(19) United States
(12) Patent Application Publication
(10) Pub. No.: US 2024/0426412 A1
(43) Pub. Date: Dec. 26, 2024

(54) Vibration-reducing and noise-absorbing pipeline with metamaterial characteristics

(71) Applicant: Tiangong University, Tianjin (CN)

(72) Inventors: Qiliang Wu, Tianjin (CN); Li Zhi, Tianjin (CN); Minghui Yao, Tianjin (CN); Yan Niu, Tianjin (CN); Cong Wang, Tianjin (CN)

(73) Assignee: Tiangong University, Tianjin (CN)

(21) Appl. No.: 18/811,765

(22) Filed: Aug. 22, 2024

(30) Foreign Application Priority Data
Jun. 11, 2024 (CN) CN202410741437.4

(51) Int. Cl. F16L 55/027

(52) U.S. Cl. CPC F16L 55/02727; F16L 9/22

(57) ABSTRACT

Disclosed is a vibration-reducing and noise-absorbing pipeline assembly with metamaterial characteristics. The assembly comprises a connecting component, a dispersion pipeline, and a flow pipeline, wherein the inner diameter of the dispersion pipeline gradually changes from small to large, and the dispersion pipeline comprises a small port and a large port. The dispersion pipeline further comprises a hose, which communicates with the interior of the flow pipeline. Fluid flows in the pipeline assembly from the connecting component to the dispersion pipeline, via a deflection portion and a guide portion, wherein with reference to a flow direction of the fluid, the deflection portion is located upstream of the guide portion, and the deflection portion is configured for changing the flow direction of the fluid, thus minimizing vibration of the pipeline assembly and damping resonance frequencies.

### CROSS-REFERENCE TO RELATED APPLICATION

This application claims priority to Chinese Patent Application No. 202410741437.4, filed on Jun. 11, 2024 before the China National Intellectual Property Administration, the disclosure of which is incorporated herein by reference in entirety.

### TECHNICAL FIELD

The present disclosure relates to the field of pipeline structures, and in particular to a vibration-reducing and noise-absorbing pipeline with metamaterial characteristics.

### BACKGROUND

Fluid-structure interaction mechanics refers to the interaction between deformed solids and fluids. The interaction between fluids and solids is common in nature. Some interactions can resist risks, for example, the forest is resistant to strong winds, and some interactions may cause safety accidents, for example, when the natural frequency of the fluid is very close to the natural frequency of the solid structure, the coupled system, consisting of the fluid and the solid, can resonate, potentially causing significant damage to the solid structure in certain instances. Fluid flows are commonly observed in building pipeline structures, such as water pipes. During the flow of fluid in the pipeline, on the one hand, it will cause the pipeline wall to vibrate and generate noise; on the other hand, the resonance may be induced by fluid-conveying pipeline system, causing pipeline damage. Therefore, it is very necessary to reduce the vibration and noisy of the pipeline.

In the existing technology for vibration reduction and noisy absorption of building pipeline, it is common to wrap a layer of sound insulation cotton on the outer wall of the pipeline. The sound insulation cotton is cheap. The material of the sound insulation cotton can be rock wool, glass fiber, etc. The principle of the sound insulation cotton is to use the fluffy and staggered tiny gaps inside the material to achieve the effect of sound absorption. Therefore, the main function of the sound insulation cotton is to absorb sound, but the vibration reduction effect is poor. However, in the fluid-structure interaction system, resonance is the primary factor in pipeline destruction, so it is necessary to reduce vibration to mitigate the risk of pipeline damage.

### SUMMARY

In order to solve the above-mentioned technical problem of “resonance leading to pipeline damage in fluid-structure interaction system”, the present disclosure provides a vibration-reducing and noise-absorbing pipeline with metamaterial characteristics, which is designed based on the principle of fluid-structure interaction mechanics. During the flow of fluid, the flow direction is continuously changed, and vibration-reduction components are used to reduce the vibration energy of fluid flow, thereby achieving the dual effects of vibration reduction and noise absorption.

The purpose of the present disclosure is to provide a vibration-reducing and noise-absorbing pipeline with metamaterial characteristics, comprising at least one pipeline assembly;
the pipeline assembly comprises a connecting component, the connecting component is connected to one end of the flow pipeline, and the other end of the flow pipeline is configured for connecting to a connecting component of another pipeline assembly; the function of the connecting component is to connect two pipeline assemblies, and the flow pipeline is the main part for the flow of liquid;
with reference to the flow direction of the fluid, the inner diameter of the dispersion pipeline gradually changes from small to large, and the dispersion pipeline (diffusion pipeline) comprises a small port and a large port, and the inner diameter of the small port is smaller than the inner diameter of the large port; the change in diameter causes the liquid flow volume to diffuse and the flow direction to change;
the dispersion pipeline comprises a hose, the dispersion pipeline is located inside the flow pipeline, the inner diameter of the flow pipeline remains unchanged, the large port is arranged at the inner wall of the flow pipeline, the large port is communicated with the inside of the flow pipeline, the small port is arranged close to the connecting component, the vibration-reducing component is arranged inside the flow pipeline, and the vibration-reducing component is wrapped outside the dispersion pipeline; the vibration-reducing component has the function of vibration-reducing and sound-absorbing;
the fluid flows from the connecting component to the dispersion pipeline in the pipeline assembly, and flows through the connecting component, the dispersion pipeline and the flow pipeline in sequence, achieving the dual effects of vibration reduction and sound absorption.

In some embodiments, the dispersion pipeline is truncated pyramid-shaped or truncated cone-shaped. Regardless of the shape, the dispersion pipeline includes a small port and a large port, and the fluid flows from the small port to the large port.

In some embodiments, the dispersion pipeline includes a deflection portion and a guide portion, the deflection portion is connected to the guide portion, and the deflection portion and the guide portion are communicated with each other. In terms of the direction of fluid flow, the deflection portion is located upstream of the guide portion, and the deflection portion is configured for changing the original flow direction of the fluid. The guide portion includes the small port and the large port, the inner diameter of the small port is smaller than the inner diameter of the large port, and the deflection portion is a hose.

In some embodiments, the deflection portion is a cylinder or a polygonal prism, and a plurality of channels are arranged inside it. The plurality of channels are arranged around the central axis of the deflection portion, and the channels cross with the direction of the flow pipeline of the pipeline assembly in which the channels are located, that is, the channels are inclined relative to the central axis of the flow pipeline in which they are located. Optionally, the plurality of channels are distributed in a circular array around the central axis of the deflection portion, so the structure is symmetrical, beautiful, and firm.

In some embodiments, the angle between the channel and the central axis of the flow pipeline is 30-70 degrees; the length of the deflection portion is 2-4 cm; the channel is an inclined cylindrical shape with an inner diameter of 1-10 mm.

In some embodiments, the deflection portion is a solid cylinder or a solid polygonal prism, and the plurality of channels arranged inside the deflection portion are all hollow, and the inner walls of the plurality of channels are all smooth.

In some embodiments, if the deflection portion is a cylinder, the guide portion is a truncated cone; if the deflection portion is a polygonal prism, the guide portion is a truncated pyramid.

In some embodiments, the vibration-reducing component is of an integral structure having a cavity, the shape of which matches the shape of the outer wall of the dispersion pipeline, and the cavity can be matched with the outside of the dispersion pipeline, and a first filling cavity is arranged inside the vibration-reducing component, and the first filling cavity is of a hollow structure filled with a first filler.

In some embodiments, the first filler is air, or a mixture of the first movable ball and air.

In some embodiments, the material of the first movable ball is any one of hard plastic, iron, steel, and copper.

In some embodiments, the vibration-reducing component is formed by splicing a plurality of vibration-reducing parts, each vibration-reducing part includes a contact surface and a notch surface. The contact surfaces of adjacent vibration-reducing parts are abutted. All vibration-reducing parts are distributed around the periphery of the dispersion pipeline, and after wrapping the dispersion pipeline, the adjacent contact surfaces are abutted, and all the notch surfaces form a cavity structure. The shape of the cavity structure matches the dispersion pipeline. A second filling cavity is provided in the vibration-reducing part. The second filling cavity is of a hollow structure filled with a second filler.

In some embodiments, the second filler is air, or a mixture of a second movable ball and air.

In some embodiments, the number of pipeline assemblies is one, or the number of pipeline assemblies is two or an integer more than two. When the number of pipeline assemblies is greater than or equal to 2, multiple pipeline assemblies are connected to form a long pipeline structure.

In some embodiments, the material of the connecting component is any one of copper, steel, steel plastic, aluminum plastic, galvanized material, carbon fiber, ceramic and nylon.

In some embodiments, a sealing component is provided between the connecting component and the connected flow pipeline, and between the connecting component and the connected water storage source equipment.

In some embodiments, the material of the flow pipeline is any one of copper pipe, galvanized pipe, aluminum-plastic pipe, plastic pipe, steel pipe, steel-plastic pipe, steel-plastic composite pipe, aluminum-plastic composite pipe, carbon fiber composite pipe, ceramic composite pipe, nylon composite pipe, and cast iron pipe.

Compared with the prior art, the present disclosure has the following beneficial effects:

The present disclosure provides a vibration-reducing and noise-absorbing pipeline with metamaterial characteristics. The overall inventive concept is: based on the principle of fluid-structure interaction mechanics, the flow direction is continuously changed during the flow of the fluid, and the vibration-reducing components are used to reduce the vibration energy of the fluid flow to achieve the vibration-reducing effect; meanwhile, since the vibration-reducing components reduce the vibration energy of the fluid flow, the noise generated by the vibration is also reduced, and finally the dual effects of vibration reduction and noise reduction are achieved.

In the present disclosure, the dispersion pipeline and the flow pipeline constitute the main pipeline for fluid flow, it is also the main path and place for fluid flow. The dispersion/diffusion pipeline is used to disperse/diffuse the fluid flowing out of the upstream flow pipeline, change the flow direction of the fluid and enter the flow pipeline of the pipeline assembly where it is located. Under the action of the vibration-reducing components, the fluid achieves the first vibration reduction. Since the diameter of the dispersion pipeline changes from small to large, and the flow direction of the fluid is from the small port to the large port, the space for fluid flow also becomes larger, then the dispersed fluid is subjected to the second vibration reduction effect. The vibration energy of the fluid is reduced, and the noise generated by the vibration is also reduced.

In the present disclosure, the soft deflection part and the hard flow pipeline form a soft and hard interlaced and periodically changing pipeline, which generates a fluid-structure interaction effect with the fluid and the pipeline and the fluid affects each other. Due to the large deformation capacity of the hose, the vibration caused by fluid-structure interaction and other reasons for fluid flow is diffused at the hose, and then diffused to the vibration-reducing components. The vibration-reducing components consume the energy of the vibration to achieve the vibration reduction effect. When the vibration is reduced, the noise is also reduced. The vibration reduction process can also avoid pipeline damage caused by severe resonance in the fluid-structure interaction system.

It should be noted that, in the present disclosure, the vibration-reducing component is innovatively arranged inside the flow pipeline, the change in the diameter size of the dispersion pipeline supports the vibration-reducing component. On the one hand, the vibration-reducing component can directly offset the force of the fluid flowing from the upstream and reduce the vibration effect of the fluid on the wall of the flow pipeline; on the second hand, the filler inside the vibration-reducing component can consume the vibration energy of the fluid on the wall of the flow pipeline; on the third hand, it is ensured that the outer wall of the flow pipeline is free of debris, which is safe in the building environment. The flow pipeline can be directly exposed or covered with building materials such as cement, and the covering does not affect the vibration reduction and noise reduction effect of the vibration-reducing component.

### BRIEF DESCRIPTION OF THE DRAWINGS

FIG. 1 is a structural schematic view of the vibration-reducing and noise-absorbing pipeline with metamaterial characteristics of the present disclosure.

FIG. 2 is a longitudinal cross-sectional view of the pipeline assembly of the present disclosure.

FIG. 3 is a three-dimensional structural view of the pipeline assembly of the present disclosure.

FIG. 4 is a three-dimensional structural view of the dispersion pipeline of the present disclosure.

FIG. 5 is a three-dimensional structural view of the vibration-reducing component spliced by multiple vibration-reducing parts of the present disclosure.

FIG. 6 is a structural view of multiple vibration-reducing parts of the present disclosure after disassembly.

### DETAILED DESCRIPTION OF EMBODIMENTS

In order to enable those skilled in the art to better understand that the technical solution of the present disclosure can be implemented, the present disclosure is further described below in conjunction with specific embodiments and drawings.

In the description of the present disclosure, it should be understood that the terms “center”, “longitudinal”, “lateral”, “length”, “width”, “thickness”, “up”, “down”, “front”, “rear”, “left”, “right”, “vertical”, “horizontal”, “top”, “bottom”, “inside”, “outside”, “clockwise”, “counterclockwise”, “axial”, “radial”, “circumferential” and the like indicate the orientation or position relationship that is based on the orientation or position relationship shown in the drawings, they are just used for the convenience of describing the present disclosure and simplifying the description, rather than indicating or implying that the device or element referred to must have a specific orientation, be constructed and operated in a specific orientation, and therefore they cannot be understood as a limitation of the present disclosure.

The terms “first” and “second” are used only for descriptive purposes, and cannot be understood as indicating or implying relative importance or implicitly indicating the number of technical features indicated. Therefore, the features defined as “first” and “second” may explicitly or implicitly include one or more of the features; in the description of the present disclosure, unless otherwise specified, “multiple” means two or more.

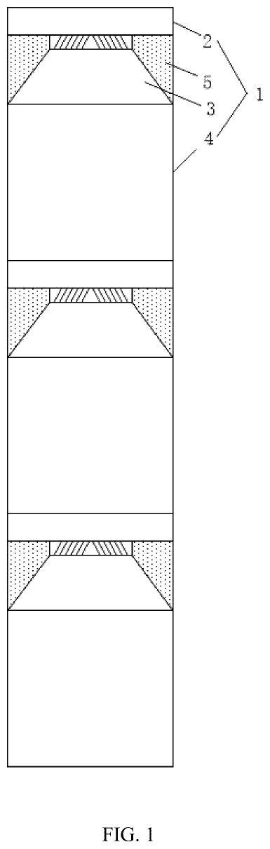

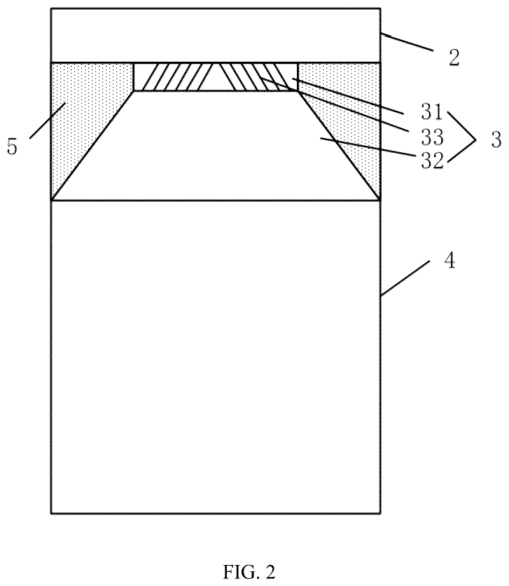

In the present disclosure, the term “the direction of fluid flow” refers to the direction from top to bottom in FIG. 1, and also corresponds to the direction from top to bottom in FIGS. 2, 3, 4, 5 and 6.

There are many types of pipelines used in the fields of construction engineering, mechanical engineering, aerospace and medicine, for example, natural gas pipelines, water pipelines, oil pipelines, liquid pipelines, etc., wherein liquid flows in the water pipelines, oil pipelines and liquid pipelines. Taking tap water pipes as an example, since tap water is supplied to high floors, the tap water pressure is usually high. Because people have different water habits and water use times, the water flow time is intermittent and irregular, which is easy to generate large noise. Therefore, pipeline silencing is a necessary operation. On the other hand, a fluid-structure interaction system may be formed between the fluid and the pipeline. In addition, the tap water itself has too high pressure. The superposition of multiple factors can easily cause pipeline damage, so vibration reduction is also very necessary. However, the main function of the method of wrapping the pipeline with sound insulation cotton in the existing building environment is to absorb sound, and the sound insulation cotton is wrapped on the outside of the pipeline, therefore it is difficult to resist and dissipate the vibration energy of the fluid inside the pipeline.

Based on the reasons summarized above, the present disclosure provides a vibration-reducing and noise-absorbing pipeline with metamaterial characteristics, which is designed based on the principle of fluid-structure interaction mechanics. During the flow of the fluid, the flow direction is continuously changed, and the vibration energy of the fluid flow is reduced under the action of the vibration-reducing component 5, finally achieving the dual effects of vibration reduction and noise reduction.

Note that the “vibration” described in the present disclosure refers to the vibration wave generated on the pipeline wall during the flow of the fluid. This vibration wave can be propagated along the pipeline wall. In addition, the sound wave of pipeline noise can also be propagated along the pipeline wall, which is different from the collision vibration between molecules inside the fluid.

Referring to FIG. 1, the vibration-reducing and noise-absorbing pipeline with metamaterial characteristics of the present disclosure includes at least one pipeline assembly 1. Since the length of the pipeline used in the construction industry cannot be specifically determined, pipeline assemblies 1 with a specific distance are usually used. After multiple pipeline assemblies 1 are spliced together, a longer pipeline structure is formed to meet the actual use requirements.

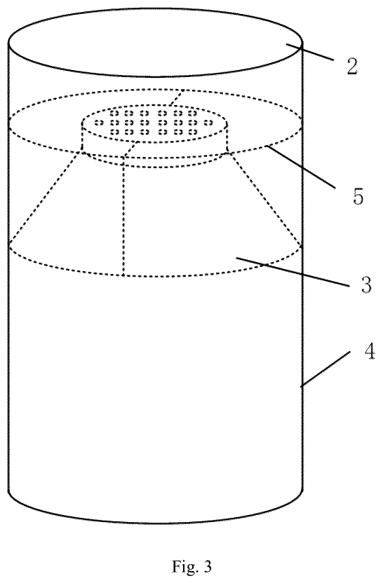

Referring to FIGS. 2 and 3, the pipeline assembly 1 includes a connecting component 2, a dispersion pipeline 3, a flow pipeline 4 and a vibration-reducing component 5. The connecting component 2 is connected to one end of the flow pipeline 4, and the other end of the flow pipeline 4 is used to connect the connecting component 2 of another pipeline assembly 1. The inner diameter of the dispersion pipeline 3 changes from small to large, and includes a small port and a large port, and the inner diameter of the small port is smaller than the inner diameter of the large port. The dispersion pipeline 3 is located inside the flow pipeline 4, and the edge of the large port is fixed to the inner wall of the flow pipeline 4, and the large port is communicated with the inside of the flow pipeline 4, and the small port is arranged near the connecting component 2, and the small port is also communicated with the inside of the flow pipeline 4. The vibration-reducing component 5 is also arranged inside the flow pipeline 4, and the vibration-reducing component 5 is wrapped outside the dispersion pipeline 3.

In the above pipeline structure, the dispersion pipeline 3 and the flow pipeline 4 constitute the main pipeline for fluid flow, it is also the main path and place for fluid flow. With reference to the direction of fluid flow, the inner diameter of the dispersion pipeline 3 changes from small to large, and the inner diameter of the flow pipeline 4 remains unchanged. The connecting component 2 is used to connect two adjacent pipeline assemblies 1 together. When the two adjacent pipeline assemblies 1 are connected, the dispersion pipeline 3 is used to disperse the fluid flowing out of the upstream flow pipeline 4, change the flow direction of the fluid and allow the fluid to enter the flow pipeline 4 of the pipeline assembly 1. Under the action of the vibration-reducing component 5, the fluid achieves the first vibration reduction. Since the inner diameter of the dispersion pipeline 3 changes from small to large, and the flow direction of the fluid is from the small port to the large port, the space for the fluid flow also becomes larger, then the dispersed fluid is subjected to the second vibration reduction. The vibration energy of the flow is reduced, and the noise generated by the vibration is also reduced accordingly.

In some embodiments, the dispersion pipeline 3 is any one of a truncated pyramid-shape and a truncated cone-shape, including a small port and a large port, and the inner diameter of the small port is smaller than the inner diameter of the large port. In the process of the fluid flowing from the small port to the large port, the flow space becomes larger, the flow direction is dispersed, and the vibration reduction effect is achieved.

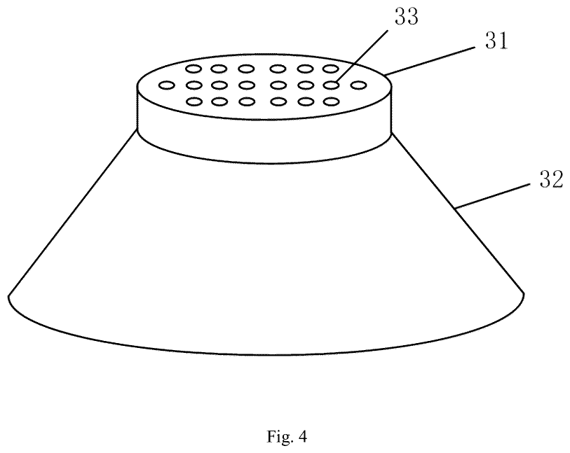

In some embodiments, referring to FIG. 4, the dispersion pipeline 3 includes a deflection (direction-changing) portion 31 and a guide portion 32, and the deflection portion 31 is fixedly connected to the guide portion 32, and the two are communicated with each other. With reference to the direction of fluid flow, the deflection portion 31 is located upstream of the guide portion 32, that is, the deflection portion 31 is arranged closer to the connecting component 2 of the pipeline assembly 1 in which it is located. The deflection portion 31 is used to change the original flow direction of the fluid. For example, if the original flow direction of the fluid is vertical, after it flows through the deflection portion 31, the flow direction of the fluid becomes inclined relative to the vertical direction. The guide portion 32 includes a small port and a large port, and the inner diameter of the small port is smaller than the inner diameter of the large port. The guide portion 32 is a part that allows to enlarge the flow space for the fluid.

Exemplarily, the deflection portion 31 is a cylinder or a polygonal prism, and a plurality of channels 33 are arranged inside it. The plurality of channels 33 are arranged around the central axis of the deflection portion 31 and arranged in a circular array. The channels cross with the direction of the central axis of the flow pipeline 4 of the pipeline assembly 1 in which the channels 33 are located, that is, the channels 33 are inclined relative to the central axis of the flow pipeline 4 in which they are located. If the flow pipeline 4 is in a vertical direction, the channels 33 are inclined relative to the vertical direction. In actual building use scenarios, the flow pipeline 4 is mostly arranged vertically. The reason for the vertical arrangement relies on the gravity of the fluid. Gravity is vertically downward, so the vertically arranged flow pipeline 4 has little resistance to the fluid and its internal molecules.

For example, the angle between the channels 33 and the central axis of the flow pipeline 4 is 30-70 degrees, for example, 30 degrees, 40 degrees, 50 degrees, 60 degrees, or 70 degrees. For example, the length dimension of the deflection portion 31, that is, the height dimension of the deflection portion 31 shown in FIG. 2 is 2-4 cm, for example, 2 cm, 3 cm, or 4 cm. Exemplarily, the channel 33 is of an inclined cylindrical shape, and its inner diameter is 1-10 mm, for example 1 mm, 3 mm, 5 mm, 7 mm, 9 mm, or 10 mm. The design of the angle, length, and inner diameter described in this paragraph has a better dispersion effect on the fluid.

Exemplarily, the deflection portion 31 is a solid cylinder or a polygonal prism, and a plurality of channels 33 are arranged inside the deflection portion 31, they are all hollow, and the inner walls of all the plurality of channels 33 are smooth.

Exemplarily, if the deflection portion 31 is a cylinder, the guide portion 32 is a truncated cone; if the deflection portion is a polygonal prism, the guide portion 32 is a truncated pyramid. The guide portion 32 includes a small port and a large port, and the inner diameter of the small port is smaller than the inner diameter of the large port.

In the present disclosure, the deflection portion 31 is a hose, and its material is any one of PVC, PPR, PE-RT, and rubber. Within the scope of the inventive concept of the present disclosure, those skilled in the art may also choose other soft pipeline materials. Referring to FIG. 3, the vibration-reducing component 5 is sleeved on the outside of the dispersion pipeline 3 and it completely wraps the outer wall of the dispersion pipeline 3. The soft deflection portion 31 and the hard flow pipeline 4 form a soft and hard interlaced, periodically changing, metamaterial performance pipeline, which generates a fluid-structure interaction effect with the fluid and the pipeline and the fluid affects each other. Due to the large deformation capacity of the hose, the vibration caused by fluid-structure interaction and other reasons of fluid flow is diffused at the hose/deflection portion 31, and then diffused to the vibration-reducing component 5. The vibration-reducing component 5 consumes the energy of the vibration to achieve the vibration reduction effect. When the vibration is reduced, the noise is reduced accordingly. The vibration reduction process can avoid pipeline damage caused by severe resonance of the fluid-structure interaction system.

In some embodiments, referring to FIG. 3, the vibration-reducing component 5 is of an integral structure having a cavity, and the shape of the cavity matches the shape of the outer wall of the dispersion pipeline 3, so that the cavity of the vibration-reducing component 5 can be matched with the outside of the dispersion pipeline 3. With reference to the direction of fluid flow, the upstream end of the vibration-reducing component 5 is provided with an opening, and the opening 52 corresponds to the top of the cavity, and the upstream end of the dispersion pipeline 3 is arranged through the opening, for example, the deflection portion 31 is disposed at the opening. In order to achieve the effect of vibration reduction and silencing, a first filling cavity is arranged inside the vibration-reducing component 5, and the first filling cavity is a hollow structure. The vibration-reducing component 5 is a capsule made of soft material, such as rubber, nylon cloth or polyurethane material. The first filling cavity inside the soft material can be deformed.

Exemplarily, air is filled in the first filling cavity, and then, after the wave transmitted through the dispersion pipeline 3 contacts the vibration-reducing component 5, it is diffused into the air therein, then it is converted into the kinetic energy of gas molecules, and gradually consumed, so as to achieve the vibration reduction effect.

Exemplarily, the first filling cavity is filled with a mixture of a first movable ball and air. The first movable ball can move freely in the first filling cavity. After the wave transmitted through the dispersion pipeline 3 contacts the vibration-reducing component 5, it is diffused into the air and the first movable ball therein, then it is converted into the kinetic energy of gas molecules and the first movable ball, and gradually consumed, to achieve the vibration reduction effect. The first movable ball consumes energy faster.

Exemplarily, the material of the first movable ball is any one of hard plastic, iron, steel, and copper. Since the density of different materials is different, the mass of the first movable ball of different materials is different, and the energy consumed by movement is also different. Those skilled in the art may select the material according to actual needs. Of course, other materials that can be made into solid spheres are also within the inventive concept of the present disclosure.

Exemplarily, the shape of the first movable ball is any one of a sphere, an ellipsoid, a cube, a cuboid, a truncated cone, and a cylinder, or a mixture of several of them. The movement of the first movable ball is the main reason for consuming the energy of the vibration wave, and the gap between different first movable balls is also the main means for sound absorption and silencing.

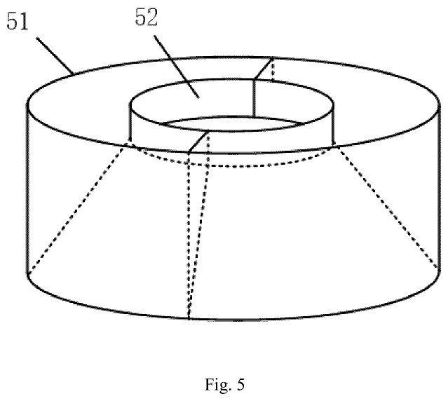

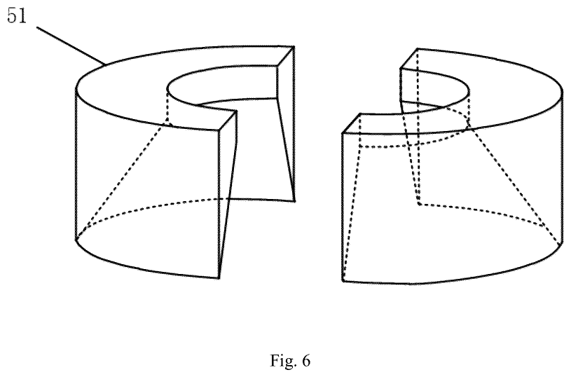

In some other embodiments, referring to FIG. 5 and FIG. 6, the vibration-reducing component 5 is composed of a plurality of vibration-reducing parts 51, for example, one vibration-reducing component 5 includes 2-8 vibration-reducing parts 51. FIGS. 5-6 show a vibration-reducing component 5 including 2 vibration-reducing parts 51. Each vibration-reducing part 51 has the same structure, and a plurality of vibration-reducing parts 51 are distributed around the periphery of the dispersion pipeline 3 and wrap the dispersion pipeline 3. The vibration-reducing part 51 includes a contact surface and a notch surface, and the contact surfaces of adjacent vibration-reducing parts 51 abut against each other. After all vibration-reducing parts 51 are distributed around the periphery of the dispersion pipeline 3 and wrap the dispersion pipeline 3, the adjacent contact surfaces abut against each other, and all the notch surfaces form a cavity structure, and the shape of the cavity structure matches the dispersion pipeline 3. A second filling cavity is provided in the vibration-reducing part 51, and the second filling cavity is of a hollow structure. The vibration-reducing part 51 is a capsule made of soft material, such as rubber, nylon cloth or polyurethane material. The second filling cavity inside the soft material can be deformed.

Exemplarily, the second filling cavity is filled with air, and then, after the wave transmitted through the dispersion pipeline 3 contacts the vibration-reducing component 5, it is diffused into the air therein, then it is converted into the kinetic energy of gas molecules, and gradually consumed, to achieve the vibration reduction effect. The second movable ball also consumes energy quickly.

Exemplarily, the second filling cavity is filled with a mixture of a second movable ball and air, and the second movable ball can move freely. After the wave transmitted through the dispersion pipeline 3 contacts the vibration-reducing part 51, it is diffused into the air and the second movable ball therein, then it is converted into the kinetic energy of gas molecules and the second movable ball, and gradually consumed, to achieve the vibration reduction effect.

Exemplarily, the material of the second movable ball is any one of hard plastic, iron, steel, and copper. Due to the different densities of different materials, the energy consumed by the movement of the second movable balls of different materials is also different. Those skilled in the art may select the material according to actual needs.

Exemplarily, the shape of the second movable ball is any one of a sphere, an ellipsoid, a cube, a cuboid, a truncated cone, and a cylinder, or a mixture of several of them. The movement of the second movable ball consumes the energy of the vibration wave, and the gap between different second movable balls is also the main means for sound absorption and silencing.

In some embodiments, the number of pipeline assemblies 1 is one, which is suitable for fluid transmission over a shorter distance. One end of the connecting component 2 is connected to the water storage source equipment, and the other end of the connecting component 2 is connected to the flow pipeline 4.

In some embodiments, the number of pipeline assemblies 1 is two or an integer more than two, which is suitable for fluid transmission over a longer distance. According to the direction of fluid flow, one end of the first connecting component 2 is connected to the water storage source equipment, and the remaining connecting components 2 are connected to two adjacent flow pipelines 4.

Exemplarily, the material of the connecting component 2 is any one of copper, steel, steel plastic, aluminum plastic, galvanized material, carbon fiber, ceramic and nylon. Those skilled in the art may also choose other materials. As long as the function of the connecting component 2 is to connect the water storage source equipment and connect the two adjacent flow pipelines 4, the connecting component 2 of any material is within the scope of the inventive concept of the present disclosure.

In order to avoid water leakage at the connecting component 2, a sealing component is provided between the connecting component 2 and the connected flow pipeline 4, and between the connecting component 2 and the connected water storage source equipment.

Exemplarily, the sealing component is a material with sealing and waterproof effects such as a sealing waterproof glue and a sealing waterproof tape.

In order to facilitate the connection between the connecting component 2 and the flow pipeline 4 or the water storage source equipment, the inner diameter of the connecting component 2 is larger than the outer diameter of the water outlet of the flow pipeline 4 and the water storage source equipment. In the actual connection process, the water outlet or the flow pipeline 4 is inserted into the connecting component 2.

For example, the length of a flow pipeline 4 is set to 1-4 meters to meet the common fluid transmission distance requirements.

For example, the wall thickness of the flow pipeline 4 is between 0.3-1 cm, for example, 0.3 cm, 0.5 cm or 1 cm. The thicker the pipeline wall is, the longer the service life of the pipeline is and the better the soundproofing effect is.

For example, the material of the flow pipeline 4 is any one of copper pipe, galvanized pipe, aluminum-plastic pipe, plastic pipe, steel pipe, steel-plastic pipe, steel-plastic composite pipe, aluminum-plastic composite pipe, carbon fiber composite pipe, ceramic composite pipe, nylon composite pipe, and cast iron pipe.

It should be noted that the materials of the connecting component 2 and the flow pipeline 4 of the present disclosure can be selected from all hard pipeline materials suitable for construction, machinery, aircraft and medicine. Those skilled in the art can also select other pipeline materials within the scope of the inventive concept of the present disclosure.

Exemplarily, the shape of the flow pipeline 4 is any one of a cylinder and a polygonal prism, which can realize the fluid flow function and can match and connect with the dispersion pipeline 3, the connecting component 2 and the vibration-reducing component 5, all of these are within the scope of the inventive concept of the present disclosure.

Exemplarily, the pipe wall of the flow pipeline 4 includes an outer wall and an inner wall, and the inner wall has a smooth, corrugated or other rough surface. The corrugation and other forms of rough surfaces have the function of dispersing the fluid and changing the flow direction of the fluid, and have a vibration reduction and noise reduction effect. Of course, in order to better match and connect with the dispersion pipeline 3, the connecting component 2 and the vibration-reducing component 5, it is preferred for the flow pipeline 4 to use a smooth inner wall.

It should be noted that the connection relationship of the components not specifically mentioned in the present disclosure is assumed to adopt the existing technology. Since it does not involve the invention point and is widely used in the existing technology, the structural connection relationship is not described in detail.

It should be noted that when the numerical range is involved in the present disclosure, it should be understood that the two endpoints of each numerical range and any value between the two endpoints can be selected. Since the steps and methods used are the same as those in the embodiment, the present disclosure only describes the preferred embodiments, so as to avoid redundancy. Although the preferred embodiments of the present disclosure have been described, those skilled in the art may make additional changes and modifications to these embodiments once they are aware of the basic creative concepts. Therefore, the appended claims are intended to be interpreted as including the preferred embodiments and all changes and modifications that fall within the scope of the present disclosure.

Obviously, those skilled in the art may make various changes and modifications to the present disclosure without departing from the spirit and scope of the present disclosure. Thus, if these modifications and variations of the present disclosure fall within the scope of the claims of the present disclosure and their equivalents, the present disclosure is also intended to include these modifications and variations.

What is claimed is:

1. A vibration-reducing and noise-absorbing pipeline with metamaterial characteristics, comprising at least one pipeline assembly (1);
wherein the pipeline assembly (1) comprises a connecting component (2), a dispersion pipeline (3), and a flow pipeline (4);
wherein the connecting component (2) is connected to one end of the flow pipeline (4), and the other end of the flow pipeline (4) is configured for connecting to a connecting component (2) of another pipeline assembly (1); an inner diameter of the dispersion pipeline (3) gradually changes from small to large, and the dispersion pipeline comprises a small port and a large port, and an inner diameter of the small port is smaller than an inner diameter of the large port; the dispersion pipeline (3) comprises a hose, which is located inside the flow pipeline (4); an inner diameter of the flow pipeline (4) remains unchanged; the large port is arranged on an inner wall of the flow pipeline (4) and communicates with an inside of the flow pipeline (4); the small port is arranged close to the connecting component (2), and the dispersion pipeline (3) is wrapped with a vibration-reducing component (5) outside;
wherein a fluid flows in the pipeline assembly (1) from the connecting component (2) to the dispersion pipeline (3);
wherein the dispersion pipeline (3) comprises a deflection portion (31) and a guide portion (32), and the deflection portion (31) is connected to the guide portion (32), and the deflection portion and the guide portion are communicated with each other;
wherein with reference to a flow direction of the fluid, the deflection portion (31) is located upstream of the guide portion (32), the deflection portion (31) is configured for changing an original flow direction of the fluid, the guide portion (32) comprises the small port and the large port, and the deflection portion (31) is the hose;
wherein the deflection portion (31) is a cylinder or a polygonal prism, and a plurality of channels (33) are arranged inside the deflection portion (31), and the plurality of channels (33) are arranged around a central axis of the deflection portion (31), and the channels (33) are inclined relative to a central axis of the flow pipeline (4) in which they are located.

2. The vibration-reducing and noise-absorbing pipeline with metamaterial characteristics according to claim 1, wherein the dispersion pipeline (3) is of truncated pyramid or truncated cone.

3. The vibration-reducing and noise-absorbing pipeline with metamaterial characteristics according to claim 1, wherein an angle between the channel (33) and the central axis of the flow pipeline (4) in which they are located is 30-70 degrees.

4. The vibration-reducing and noise-absorbing pipeline with metamaterial characteristics according to claim 1, wherein if the deflection portion (31) is a cylinder, then the guide portion (32) is a truncated cone; if the deflection portion (31) is a polygonal prism, then the guide portion (32) is a truncated pyramid.

5. The vibration-reducing and noise-absorbing pipeline with metamaterial characteristics according to claim 1, wherein the vibration-reducing component (5) is of an integral structure having a cavity, the cavity is matched with an outside of the dispersion pipeline (3), a first filling cavity is provided inside the vibration-reducing component (5), and the first filling cavity is filled with a first filler.

6. The vibration-reducing and noise-absorbing pipeline with metamaterial characteristics according to claim 5, wherein the first filler is air, or a mixture of a first movable ball and air.

7. The vibration-reducing and noise-absorbing pipeline with metamaterial characteristics according to claim 1, wherein the vibration-reducing component (5) is formed by splicing a plurality of vibration-reducing parts (51), each vibration-reducing part (51) comprises a contact surface and a notch surface, all the vibration-reducing parts (51) are distributed around a periphery of the dispersion pipeline (3), and after completely wrapping an outer wall of the dispersion pipeline (3), adjacent contact surfaces are abutted, and all the notch surfaces form a cavity structure, the cavity structure has a shape matching with a shape of the outer wall of the dispersion pipeline (3), and the vibration-reducing part (51) is provided with a second filling cavity therein, and the second filling cavity is filled with a second filler.

8. The vibration-reducing and noise-absorbing pipeline with metamaterial characteristics according to claim 7, wherein the second filler is air, or a mixture of a second movable ball and air.
